(19) United States
(12) Patent Application Publication
(10) Pub. No.: US 2017/0054411 A1
(43) Pub. Date: Feb. 23, 2017

(54) SOLAR DEVICE DIAGNOSIS METHOD

(71) Applicant: Sinogreenergy Consultant Co. Ltd, Taipei City (TW)

(72) Inventor: Kun-Hong CHEN, Taipei City (TW)

(21) Appl. No.: 14/827,650

(22) Filed: Aug. 17, 2015

(51) Int. Cl. H02S 50/10

(52) U.S. Cl. CPC H02S 50/10

(57) ABSTRACT

A solar device diagnosis method is disclosed in the present invention and the method is to compare the data in the same one solar device at different time periods, the data in different solar devices at the same time period, and the data of the solar device with the average of the data of the multiple solar devices so as to determine the problem of the solar device. By the aforementioned diagnosis method, the data of the solar devices can be compared in many different aspects to determine whether the solar device is abnormal or not and the power generation efficiency of the solar device is enhanced.

### BACKGROUND OF THE INVENTION

1. Field of the Invention

The present invention relates to a solar device diagnosis method, and more particularly to a diagnosis method to detect multiple different data of the solar device.

2. Description of Related Art

Since energy crisis, many countries are aggressively looking for a resource of alternative energy. Alternative energy can be wind power, solar power, geothermal energy, tidal energy, and so on rather than energy using coal, petroleum, gasoline, or nuclear reactors. Solar power is inexhaustible in supply and the power generation device can be integrated with buildings. Moreover, the conversion efficiency of the solar power is increasing annually. Many countries actively promote the benefits to build solar power plants, so the solar power energy modules are widely used.

The solar power is different from the conventional electric main supply. The solar power is to connect many solar battery modules together in serial and parallel to output specific voltage and electric current. The serial connection is to increase the output voltage and the parallel connection is to increase the output electric current. Thereafter, the energy generated by the solar battery modules is converted to AC power by DC boxes and inverters and merged with the electric main supply.

FIG. 6 is a characteristic diagram of a solar battery module showing an electric current, a voltage, and a power of the solar battery module. As shown in FIG. 6, a horizontal axis stands for an output voltage of the solar battery module and a vertical axis stands for an output electric current of the solar battery module. The output efficiency of the power battery module is affected because of the ambient difference. In order to acquire the best power usage efficiency, a maximum power point (MPP) tracking technique is used in the conventional method. A MPP tracker with the MPP tracking technique is installed in the power battery module to track a voltage and current combination of the solar battery module. For example, the MPP tracker is installed in the inverter, so one MPP can be automatically detected in accordance with the voltage and electric current of the solar battery module, and the voltage (Vmp) and the electric current (Imp) corresponding to the MPP can be found. The voltage (Vmp) is an output voltage at the maximum power and the electric current (Imp) is an output electric current at the maximum power. The variation of the MPP is related to irradiance and temperature. When the irradiance is reduced, the electric current (Imp) is decreased and the MPP is also decreased. When the temperature is increased, the voltage and the maximum power are both decreased. In the conventional solar battery modules, when the ambient factor is changed, the solar battery modules are adjusted by tracking the variance of the voltage (Vmp), the electric current (Imp) or the MPP.

When the maximum power (Pmax) and the corresponding voltage (Vmp) or the corresponding electric current (Imp) of the solar battery module are not maintained within a threshold value, a warning message is transmitted to notify the manager by the MPP tracker and the manager is reminded to investigate the problem. By implementing the MPP tracker, the power condition in each one of the solar battery modules is compared with its own threshold value only. However, in the actual situation, a lot of factors can affect the power efficiency of the solar battery module. In the same time period and the same weather condition, different solar battery modules can have different outputs and it is necessary to perform different adjustments for different solar battery modules in different situations.

Accordingly, a need arises to design a method and system to monitor the power efficiency of the solar device in many different aspects rather than determining the condition of the power efficiency of the solar device by the MPP only.

### SUMMARY OF THE INVENTION

Therefore, an objective of the present invention is to provide a solar device diagnosis method to compare the data in one solar device at different time periods. The solar device is determined to be abnormal or not in accordance with the data of the solar device at different time periods so as to increase the power generation efficiency of the solar device.

According to the aforementioned objective, a solar device diagnosis method is provided in the present invention and comprises steps of:

detecting at least one first data of at least one solar device at a first time period;

detecting at least one second data of the at least one solar device at a second time period;

calculating at least one first comparison value between the at least one first data and the at least one second data; and

transmitting a first warning message when an absolute value of the at least one first comparison value is greater than a first error tolerance value;

wherein the at least one first data and the at least one second data are data with the same unit.

Another objective of the present invention is to provide a solar device diagnosis method to compare the data in different solar devices at the same time period. According to the comparison result, one of the solar devices is determined to be abnormal so as to perform maintenance or troubleshooting for the solar power plant.

According to the aforementioned objective, a solar device diagnosis method is provided in the present invention and comprises steps of:

detecting at least one first data of at least one first solar device at a first time period;

detecting at least one second data of at least one second solar device at the first time period;

calculating at least one first comparison value between the at least one first data and the at least one second data; and

transmitting a first warning message when an absolute value of the at least one first comparison value is greater than a first error tolerance value;

wherein the at least one first data and the at least one second data are data with the same unit.

Still another objective of the present invention is to provide a solar device diagnosis method to compare the data of the solar device with the average of the data of the solar devices. According the comparison result, the solar device is determined to be abnormal or not if the working status of the solar device is different from or similar to the working status of multiple solar devices.

According to the aforementioned objective, a solar device diagnosis method is provided in the present invention, and comprises steps of:

detecting a first data of a first solar device;

detecting a plurality of second data of a plurality of second solar devices;

calculating a first average value of the second data;

calculating at least one first comparison value between the first data and the first average value; and

transmitting a first warning message when an absolute value of the at least one first comparison value is greater than a first error tolerance value.

By implementing the aforementioned diagnosis method, the difference between the multiple solar devices can be determined and the difference of the data in one solar device can be determined. Therefore, the power generation efficiency of the solar device is enhanced by comparing data of the multiple solar devices rather than tracking the difference in the MPP of one single solar device as the conventional method.

### BRIEF DESCRIPTION OF THE DRAWINGS

FIG. 1 is a circuit block diagram of a solar power plant in the present invention;

FIG. 2 is a flow chart of a solar device diagnosis method in a first embodiment of the present invention;

FIG. 3 is a flow chart of the solar device diagnosis method in a second embodiment of the present invention;

FIG. 4 is a flow chart of the solar device diagnosis method in a third embodiment of the present invention;

FIG. 5 is a bar diagram of the first data D1 and the second data D2 in one solar device; and

FIG. 6 is a characteristic diagram of a solar battery module showing an electric current, a voltage, and a power of the solar battery module.

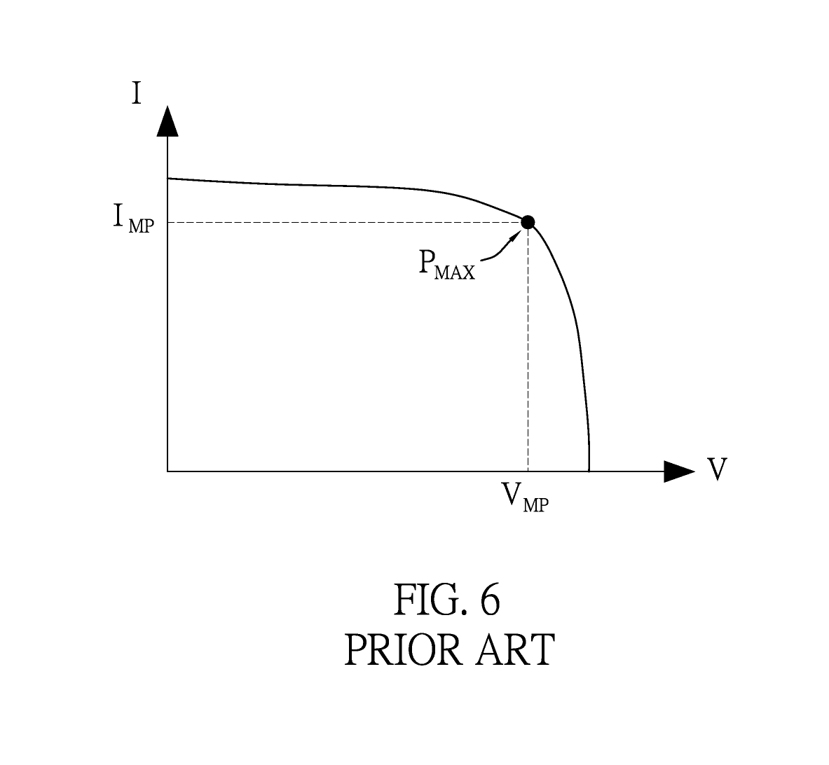

### DETAILED DESCRIPTION OF THE PREFERRED EMBODIMENT

These and other aspects of the embodiments herein will be better appreciated and understood when considered in conjunction with the following description and the accompanying drawings.

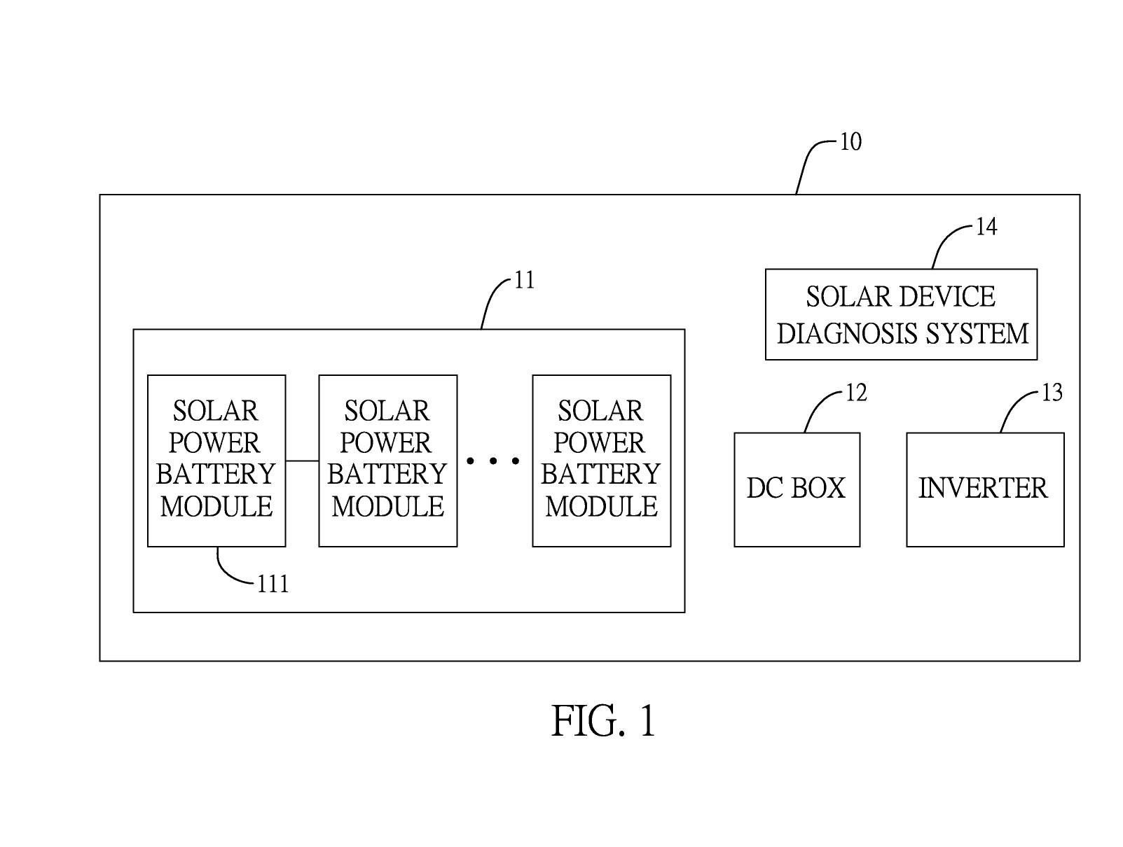

FIG. 1 is a circuit block diagram of a solar power plant in the present invention. As shown in FIG. 1, the solar power plant 10 includes a solar battery module series 11, a DC (direct current) box 12, an inverter 13, and a solar device diagnosis system 14. One solar power battery module series 11 can be used in the present invention, but in a different embodiment, the solar power plant 10 can include more than one solar power battery module series 11 to be used and it is not limited herein. The solar power battery module series 11 includes multiple solar power battery modules 111 and the solar power battery modules 111 are connected in series. The solar power battery module series 11 is connected to the DC box 12 and the DC box 12 is to collect the electric power generated by the solar power battery modules 111 and transmits the power to the inverter 13 to perform a DC/AC voltage conversion. The solar device diagnosis system 14 for the solar device in the present invention can be installed at the solar power battery module 111, the solar power battery series 11, the DC box 12 or the inverter 13, and it is not limited herein. For example, the diagnosis system 14 for the solar device is installed at the solar power battery module 111 to detect data of the solar power battery module 111. The diagnosis system 14 for the solar device is installed at the solar power battery module series 11 to detect data of the solar power battery module series 11. All the devices at the solar power plant 10 can be detecting targets of the diagnosis system 14 for the solar device. Moreover, the solar power plant 10 can be a detecting target of the diagnosis system 14 instead of detecting the MPP of the solar power battery module in the conventional method. The diagnosis method of the present invention is installed in the diagnosis system 14.

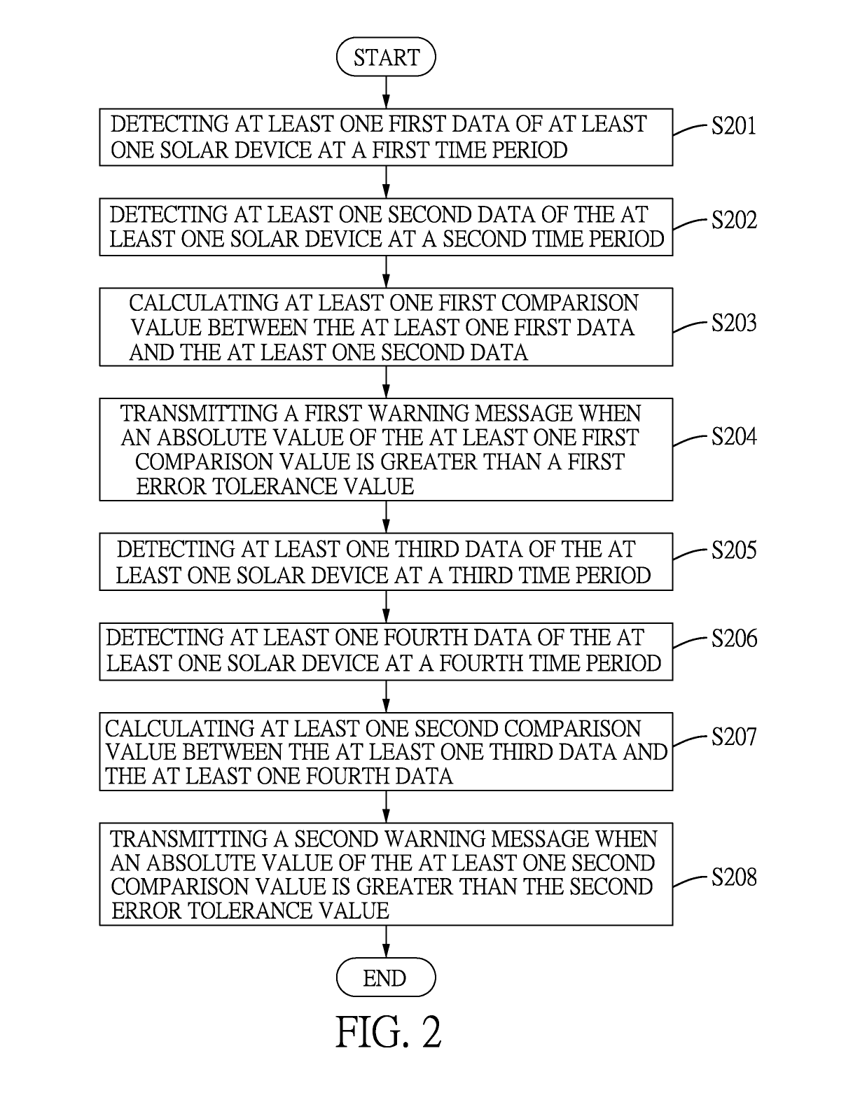

FIG. 2 is a flow chart of a solar device diagnosis method in a first embodiment of the present invention. As shown in FIG. 2, in the first embodiment, the solar device is diagnosed whether the solar device is abnormal by comparing the data in the same solar device at different time periods. In step S201, in a first time period, at least one data D1 of at least one solar device is detected. The unit of the first time period can be seconds, minutes, hours, days, months, seasons or years, and it is not limited herein. The first Data D1 of the solar device can be DC data (such as voltage, current solar device power efficiency (kWh/kWp/h), thousand watts per hour (kWh), power per unit device (kWh/kWp), instant power (kW) and so on), AC data (such as voltage, current solar device power efficiency (kWh/kWp/h), thousand watts per hour (kWh), power per unit device (kWh/kWp), instant power (kW) and so on), temperature data, ambient factor data, resistance data or leakage current data. Any DC or AC electrical parameters in the solar device, any ambient factor data, any resistance or leakage current data can be the data in the present invention, and it is not limited herein. For example, the first data D1 is a voltage value, and the voltage value can be the AC voltage detected and outputted from the solar power battery module or the converted AC voltage. When the first data D1 is a temperature value, the temperature value can be the overall temperature of the solar device or the temperature of the electronic components (such as module, inverter, breaker, diode, fuse, terminal, surge absorber, wire, DC box, AC box and so on) within the solar device. A temperature detector is installed at a place where the temperature is to be detected. When the first data D1 is an ambient factor data, the ambient factor data can be sunshine data, humidity data, temperature data, wind velocity data, wind pressure data and so on. When the first data D1 is a resistance value, the resistance value can be a DC ground resistance value, an AC ground resistance value or a serial resistance value. When the first data D1 is a leakage current, the leakage current is detected from the inverter, DC plate, AC plate, DC end or AC end. The first solar device can be the solar power battery module, the solar power battery module series, the MPP tracker of the solar power battery module, the inverter used in solar power or the solar power plant. In addition, the number of the first solar device can be more than one or more than two, and the power generation is about 1 KW-1 GW.

With reference to FIG. 2, in step S202, at least one second data D2 of the at least one solar device is detected at a second time period. In the present invention, the first time period is different from the second time period. The first data D1 and the second data D2 are data with the same unit. For example, the first data D1 and the second data D2 are temperature values or the first data D1 and the second data D2 are voltage values. Thereafter, in step S203, at least one first comparison value C1 between the first data D1 and the second data D2 is calculated. In the embodiment of the present invention, the first comparison value C1 is a differential percentage value between the first data D1 and the second data D2 and the algorithm is C1=((D2−D1)/D1)×100%. In a different embodiment, the first comparison value C1 can be a calculating value between the first data D1 and the second data D2 different from the differential percentage value, and it is not limited herein.

In step S204, a first warning message is transmitted to the manager when an absolute value of the first comparison value (|C1|) is greater than an error tolerance value. The manger is notified to realize that the solar device or the internal components are abnormal and an investigation and adjustment is required. For example, in one embodiment, if the error tolerance value is 1% and |C1| is greater than 1%, the warning message is transmitted to the manager. In addition, the warning message can be transmitted by instant message, phone, email, portable device software, non-portable device software or communication software, but it is not limited herein.

In the first embodiment of the present invention, in order to confirm whether the solar device is abnormal, the diagnosis method to compare the difference in one kind of data may not be accurate. Therefore, the diagnosis method of the present invention further includes the following steps. In step S205, at least one third data D3 of the at least one solar device is detected at a third time period. In step S206, at least one fourth data D4 of the at least one solar device is detected at a fourth time period. Then, in step S207, at least one second comparison value C2 between the at least one third data D3 and the at least one fourth data D4 is calculated. In step S208, when an absolute value of the at least one second comparison value C2 is greater than a second error tolerance value, a second warning message is transmitted to the manager. The second comparison value C2 is further calculated to confirm whether the solar device is abnormal or not. In addition, in the first embodiment, the first time period can be equal to the third time period or the second time period can be equal to the fourth time period, but it is not limited herein.

For example, the units of the first data D1 and the second data D2 are voltage. When receiving the first warning message, the manager realizes that the voltage of the solar device may be abnormal. In order to confirm that the malfunction of the solar device actually occurs, the manager is further to detect the third data D3 and the fourth data D4 of the solar device. The unit of the third data D3 and the fourth data D4 can also be the voltage. Alternatively, the unit of the third data D3 and the fourth data D4 can be electric current, temperature, or ambient factors different from the unit of the first data D1 and the second data D2. By detecting the third data D3 and the fourth data D4, the solar device is confirmed to be abnormal or not. However, the aforementioned description is to specify that the diagnosis method in the present invention can further calculate the second comparison value C2 to confirm the occurrence of the malfunction of the solar device, but it is not to limit that the diagnosis method in the present invention is to calculate the first comparison value C1 and the second comparison value C2 only. In a different embodiment, the manager can calculate more than two comparison values to further confirm whether the solar device is abnormal or not.

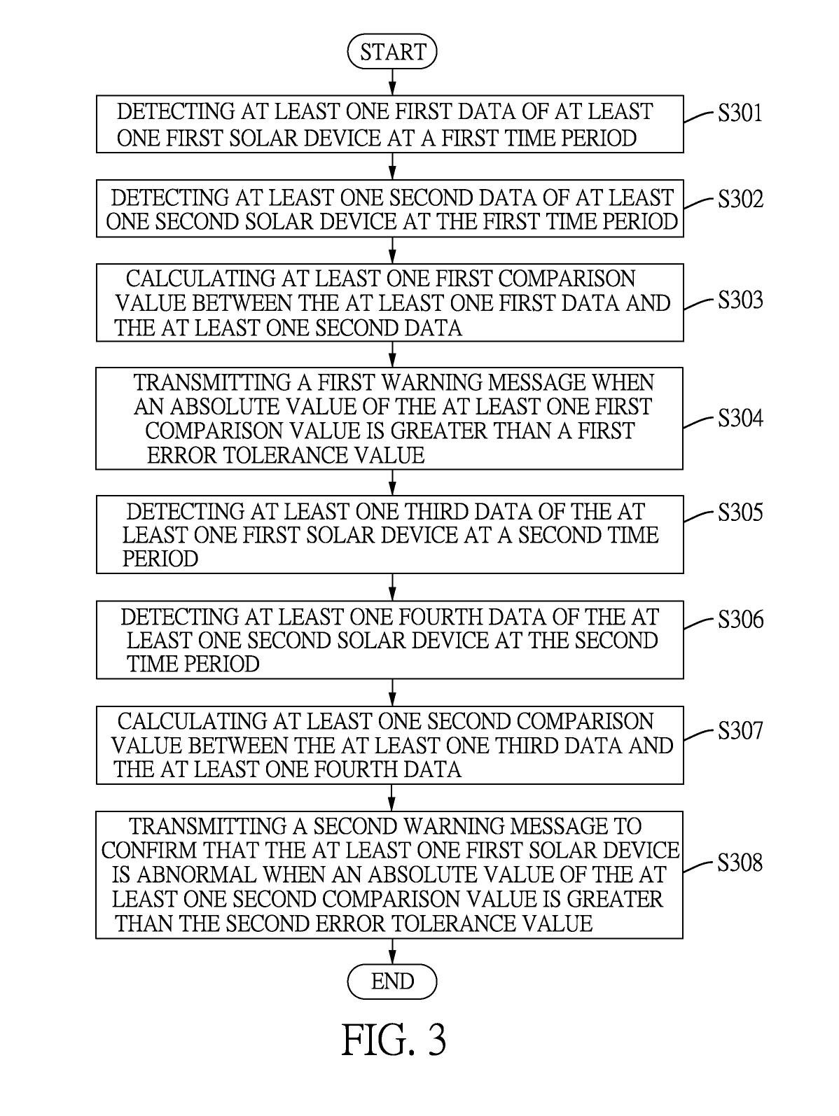

FIG. 3 is a flow chart of the solar device diagnosis method in a second embodiment of the present invention. As shown in FIG. 3, in the diagnosis method of the second embodiment, the data in different solar devices is compared to determine whether one of the solar devices is abnormal. In step S301, at least one first data D1 of at least one first solar device is detected at a first time period. In step S302, at least one second data D2 of at least one second solar device is detected at the first time period. For example, the first solar device and the second solar device can be different components at the same solar power plant. The first solar device and the second solar device can be two different components at two different solar power plants or one single solar power plant, and it is not limited herein. Now, in step S303, at least one first comparison value C1 between the first data D1 and the second data D2 is calculated. In step S304, a first warning message is transmitted when the absolute value of the first comparison value C1 is greater than a first error tolerance value. The first data D1 and the second data D2 are data with the same unit. For example, the first data D1 and the second data D2 are voltage values.

However, in a different embodiment, in order to further confirm the malfunction of the solar device, the diagnosis method in the second embodiment further includes the following steps. In step S305, at least one third data D3 of the at least one first solar device is detected at a second time period. In step S306, at least one fourth data D4 of the at least one second solar device is detected at the second time period. Then, in step S307, at least one second comparison value C2 between the at least one third data D3 and the at least one fourth data D4 is calculated. In the second embodiment, the second comparison value C2 between the third data D3 and the fourth data D4 is further calculated to confirm whether the second comparison value C2 is also too large. In step S308, a second warning message is transmitted to confirm whether the at least one first solar device is abnormal when the absolute value of the at least one second comparison value C2 is greater than a second error tolerance value. The first time period can be equal to the second time period, but the first time period can be different from the second time period in the different embodiments.

For example, the first data and the second data are voltage values, and the third data and the fourth data are electric current values. When the manager finds that the difference between the voltage values of the first solar device and the second solar device is too large, the manager further compares the difference between the electric current values of the first solar device and the second solar device to find out if the difference is also too large so as to further confirm whether the first solar device or the second solar device is abnormal. If the difference of the electric current values between the first solar device and the second solar device is also too large, the first solar device or the second solar device is confirmed to be abnormal. If the difference of the electric current values between the first solar device and the second solar device is lower than the second error tolerance value, the abnormality of the electric current values in the first solar device and second solar device may be an erroneous determination. The manager is not requested to perform maintenance or troubleshooting. Alternatively, in a different embodiment, the manager can further calculate a third comparison value one more time to further confirm the difference between another data of the first solar device and the second solar device is also too large. The malfunction of the first solar device or the second solar device is further confirmed. In the present invention, the number of the comparison can be more than once, and the data to be compared is different at each time. The solar device is confirmed to be abnormal or not by comparison in many different aspects.

In addition, in a different embodiment, the at least one second solar device in step S306 can be replaced with at least one third solar device to detect the at least one fourth data of the at least one third solar device. When the comparison value between the first data of the first solar device and the second data of the second solar device is greater than the error tolerance value, the solar device diagnosis method in the present invention can further compare the difference between the third data of the first solar device and the fourth data of the second solar device or the difference between the third data of the first solar device and the fourth data of the third solar device. The second solar device and the third solar device are different solar devices. For example, when the manager discovers that the difference of the data between the first solar device and the second solar device exists, the manger can further compare other data between the first solar device and the second solar device or further compare the data between the first solar device and the third solar device to confirm if the first solar device is malfunctioning or abnormal.

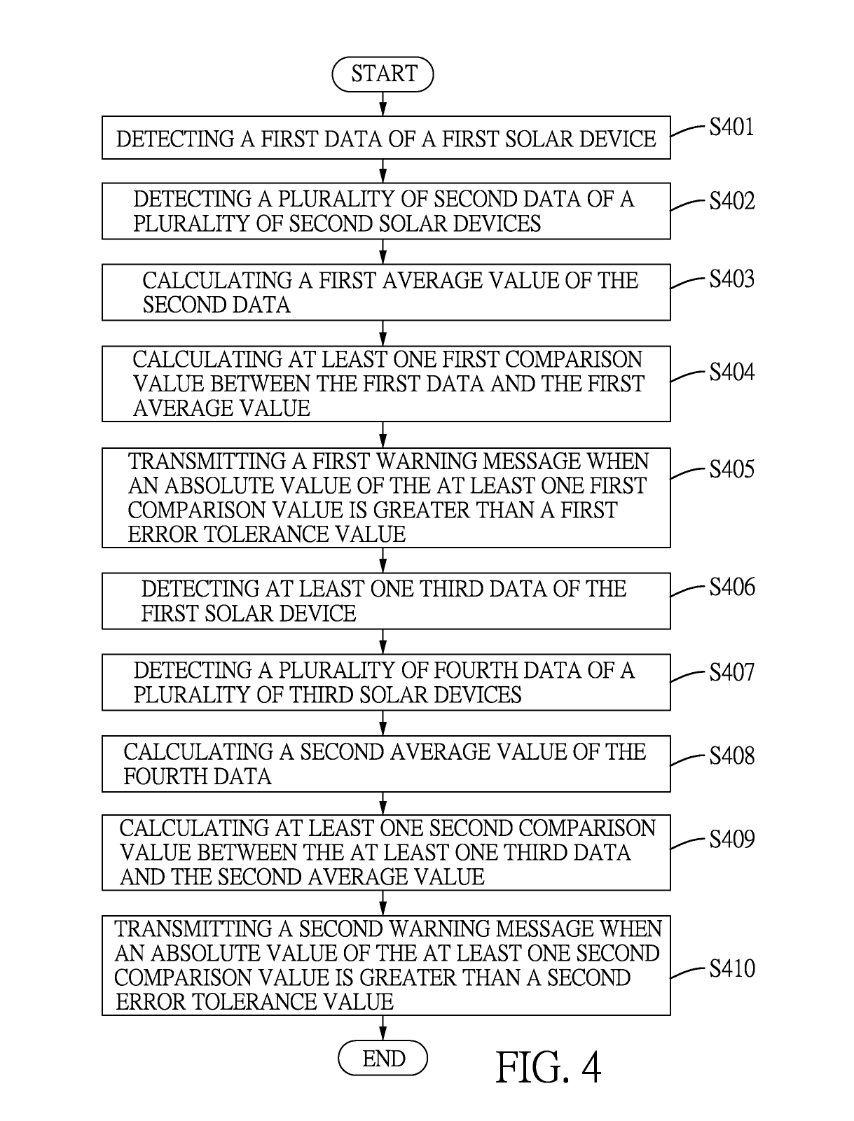

FIG. 4 is a flow chart of the solar device diagnosis method in a third embodiment of the present invention. As shown in FIG. 4, in the diagnosis method in the third embodiment, the first solar device is diagnosed to be abnormal or not by comparing the data of the first solar device with the average value of the data of the first solar device and at least one second solar device or the average value of the data of the multiple second solar devices.

In step S401, a first data D1 of a first solar device is detected. In step S402, a plurality of second data D2 of a plurality of second solar devices is detected. The plurality of second solar devices can include the first solar device or not include the first solar device, and it is not limited herein. Then, in step S403, a first average value of the plurality of second data D2 is calculated. In step S404, at least one first comparison value between the first data D1 and the first average value is calculated. In step S405, a first warning message is transmitted when absolute value of the first comparison value is greater than a first error tolerance value. In the present embodiment, the first data D1 and the second data D2 are data with the same unit. For example, the first data D1 and the second data D2 are voltage values.

However, in a different embodiment, in order to confirm the first solar device is abnormal, the diagnosis method in the third embodiment further includes the following steps. In step S406, a third data of the first solar device is detected. In step S407, a plurality of fourth data D4 of a plurality of third solar devices is detected. The plurality of third solar devices can include or not include the first solar device and/or the second solar device, and it is not limited herein.

Then, in step S408, a second average value of the plurality of the fourth data D4 is calculated. In step S409, at least one second comparison value between the third data D3 and the second average value is calculated. In the second embodiment, the second comparison between the third data D3 and the second average value is calculated to determine whether the second comparison value is too large. In step S410, a second warning message is transmitted to confirm that the first solar device is abnormal when the absolute value of the second comparison value is greater than a second error tolerance value.

In the present embodiment, the first solar device and the third solar device are solar devices with the same properties. The first data D1 and the third data D3 of the first solar device can be data with the same unit or different units. For example, if the first data D1 is a voltage value, the third data D3 can be a voltage value or an electric current value, and it is not limited herein. In addition, if the difference between the third data D3 of the first solar device and the average of the fourth data of the third solar device is less than the second error tolerance value, the abnormality of the voltage of the first solar device may be an erroneous determination and the manager is not requested to perform maintenance or troubleshooting. If the difference between the third data D3 of the first solar device and the average of the fourth data D4 of the third solar device is greater than the second error tolerance value, the abnormality of the first solar device is confirmed and the manager can perform maintenance or troubleshooting in the first solar device.

In addition, in a different embodiment, the manager can replace the third solar device in the step S407 by the second solar device. The third data D3 of the first solar device is compared with the average of the fourth data of the second solar devices to determine whether the first solar device is abnormal or not. Alternatively, the manager can calculate a third comparison value to further compare the data of the first solar device with the average value of another data to determine whether the difference is also too large so as to confirm if the first solar device is truly abnormal. In the present invention, the number of the comparison can be more than one or two, and the comparing data at each time can also be different. The solar device is determined to be abnormal by comparison for many different times in many different aspects.

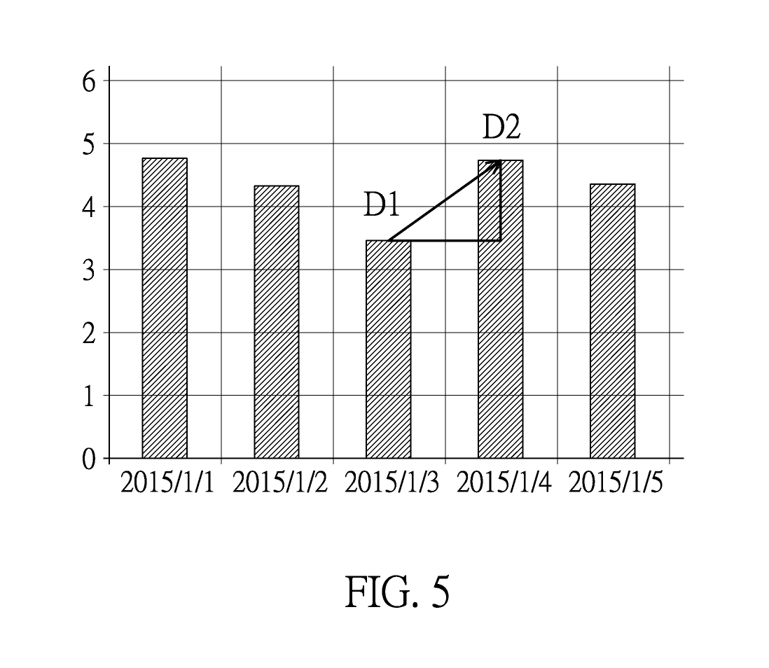

FIG. 5 is a bar diagram of the first data D1 and the second data D2 in one solar device. As shown in FIG. 5, in the bar diagram, a horizontal axis stands for date and a vertical axis can stand for DC voltage, AC voltage, temperature, environment factor, resistance, leakage current, and so on, but it is not limited herein. In the embodiment of the present invention, the values of the solar device detected in Jan. 3, 2015 (as the first time period) and Jan. 4, 2015 (as the second time period) are respectively used as the first data D1 and the second data D2. Then, the differential percentage value between the first data D1 and the second data D2 is calculated and the differential percentage value is compared with an error tolerance value. If the differential percentage value is greater than the error tolerance value, the warning message is transmitted to the manager.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A solar device diagnosis method, comprising steps of:
detecting at least one first data of at least one solar device at a first time period;
detecting at least one second data of the at least one solar device at a second time period;
calculating at least one first comparison value between the at least one first data and the at least one second data; and
transmitting a first warning message when an absolute value of the at least one first comparison value is greater than a first error tolerance value;
wherein the at least one first data and the at least one second data are data with a same unit.

2. The solar device diagnosis method as claimed in claim 1, further comprising steps of:
detecting at least one third data of the at least one solar device at a third time period;
detecting at least one fourth data of the at least one solar device at a fourth time period;
calculating at least one second comparison value between the at least one third data and the at least one fourth data; and
transmitting a second warning message when an absolute value of the at least one second comparison value is greater than a second error tolerance value;
wherein the at least one third data and the at least one fourth data are data with a same unit.

3. The solar device diagnosis method as claimed in claim 1, wherein in the step of transmitting the first warning message when the absolute value of the at least one comparison value is greater than the first error tolerance value, the first warning message is transmitted by a text message, a phone, an email, a portable device software, a non-portable device software, or a communication software.

4. A solar device diagnosis method, comprising steps of:
detecting at least one first data of at least one first solar device at a first time period;
detecting at least one second data of at least one second solar device at the first time period;
calculating at least one first comparison value between the at least one first data and the at least one second data; and
transmitting a first warning message when an absolute value of the at least one first comparison value is greater than a first error tolerance value;
wherein the at least one first data and the at least one second data are data with the same unit.

5. The solar device diagnosis method as claimed in claim 4, further comprising:
detecting at least one third data of the at least one first solar device at a second time period;
detecting at least one fourth data of the at least one second solar device at the second time period;
calculating at least one second comparison value between the at least one third data and the at least one fourth data; and
transmitting a second warning message to confirm that the at least one first solar device is abnormal when an absolute value of the at least one second comparison value is greater than a second error tolerance value;
wherein the at least one third data and the at least one fourth data are data with the same unit.

6. The solar device diagnosis method as claimed in claim 4 further comprising:
detecting at least one third data of the at least one first solar device at a second time period;
detecting at least one fourth data of at least one third solar device at the second time period;
calculating at least one second comparison value between the at least one third data and the at least one fourth data; and
transmitting a second warning message to confirm that the at least one first solar device is abnormal when an absolute value of the at least one second comparison value is greater than a second error tolerance value;
wherein the at least one third data and the at least one fourth data are data with the same unit, and the at least one first solar device and the at least one third solar device are solar devices with the same property.

7. A solar device diagnosis method, comprising steps of:
detecting a first data of a first solar device;
detecting a plurality of second data of a plurality of second solar devices;
calculating a first average value of the second data;
calculating at least one first comparison value between the first data and the first average value; and
transmitting a first warning message when an absolute value of the at least one first comparison value is greater than a first error tolerance value.

8. The solar device diagnosis method as claimed in claim 7, further comprising steps of:
detecting at least one third data of the first solar device;
detecting a plurality of fourth data of a plurality of third solar devices;
calculating a second average value of the fourth data;
calculating at least one second comparison value between the at least one third data and the second average value; and
transmitting a second warning message when an absolute value of the at least one second comparison value is greater than a second error tolerance value.

9. The solar device diagnosis method as claimed in claim 7, further comprising steps of:
detecting at least one third data of the first solar device;
detecting a plurality of fourth data of a plurality of the second solar devices;
calculating a second average value of the fourth data;
calculating at least one second comparison value between the at least one third data and the second average value; and
transmitting a second warning message when an absolute value of the at least one second comparison value is greater than a second error tolerance value.

10. The solar device diagnosis method as claimed in claim 7, wherein the second solar devices include the first solar device.
